(19) United States
(12) Patent Application Publication
(10) Pub. No.: US 2016/0079585 A1
(43) Pub. Date: Mar. 17, 2016

(54) SYSTEM AND METHOD FOR PRODUCINGBATTERY TERMINALS

(71) Applicant: Jose-Antonio KURT-MAYRL-Y-SANCHEZ-JUAREZ, (US)

(72) Inventor: Fernando MAYRL-SADA, SANTA CATARINA (MX)

(21) Appl. No.: 14/650,338

(22) PCT Filed: Dec. 5, 2013
(86) PCT No.: PCT/MX2013/000159

§ 371 Date: Nov. 30, 2015

Related U.S. Application Data
(60) Provisional application No. 61/734,206, filed on Dec. 6, 2012.

(51) Int. Cl. H01M 2/30

(52) U.S. Cl. CPC H01M 2/305

(57) ABSTRACT

Disclosed is a method and apparatus for manufacturing terminals for automotive batteries having a pressing unit, a punching unit, and a drilling unit in the same apparatus.

### BACKGROUND OF THE INVENTION

A. Field of the Invention

The present invention is related to apparatus and methods for the manufacture of terminals for automotive batteries, and more particularly to an apparatus for manufacturing terminals for automotive batteries having pressing means, punching means and drilling means in the same apparatus.

B. Description of the Related Art

All motor vehicles make use of a battery, which comprises an electric accumulator that provides electricity for example, for the starting motor of an internal combustion engine, or to the electric systems of a jet engine. Batteries that are used as energy source for an electric vehicle are called traction batteries. Hybrid vehicles may use both kind of batteries.

Such batteries have a pair of lead terminals for the positive and negative terminals respectively. The battery terminals are generally composed by a metallic tubular member having open ends and means for attaching to the battery frame formed at their external walls.

Normally, automotive battery terminals are manufactured from a lead preform, which is pressed, punched and drilled using different machines and working stations. Due to the necessity of using different machines for carrying out each forming step, the manufacturing facility must have sufficient space for accommodating the necessary machines, and the manufacturing process may be slow.

In view of the above referred problems, applicant developed a method and apparatus for the manufacture of automotive battery terminals that provide pressing means, punching means and drilling means in the same apparatus.

Since the three main stages of the manufacturing process are automatically performed on the same machine, considerable space is saved and the manufacturing process is performed in much less time.

### SUMMARY OF THE INVENTION

It is a main object of the present invention, to provide an apparatus and method for the manufacture of automotive battery terminals that provide pressing means, punching means and drilling means in the same apparatus.

It is another object of the present invention, to provide a method and apparatus for the manufacture of automotive battery terminals of the above referred nature, in which since the three main stages of the manufacturing process are automatically performed on the same machine, considerable space is saved and the manufacturing process is performed in much less time.

These and other objects and advantages of the apparatus and method for the manufacture of battery terminals of the present invention will become apparent to those persons having an ordinary skill in the art, from the following detailed description of the embodiments of the invention which will be made with reference to the accompanying drawings.

### BRIEF DESCRIPTION OF THE DRAWINGS

FIG. 1 is a frontal view of the apparatus for manufacturing battery terminals of the present invention.

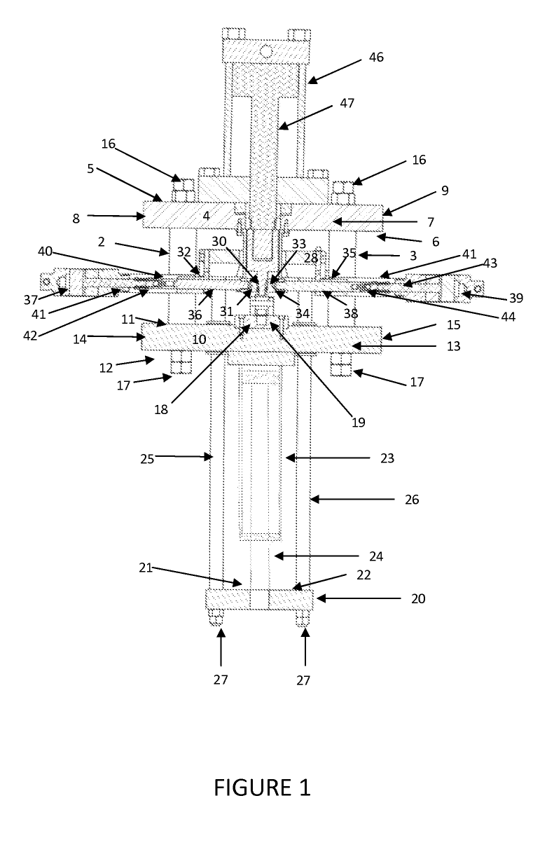

FIG. 2 is a left side view of the apparatus for manufacturing battery terminals of the present invention.

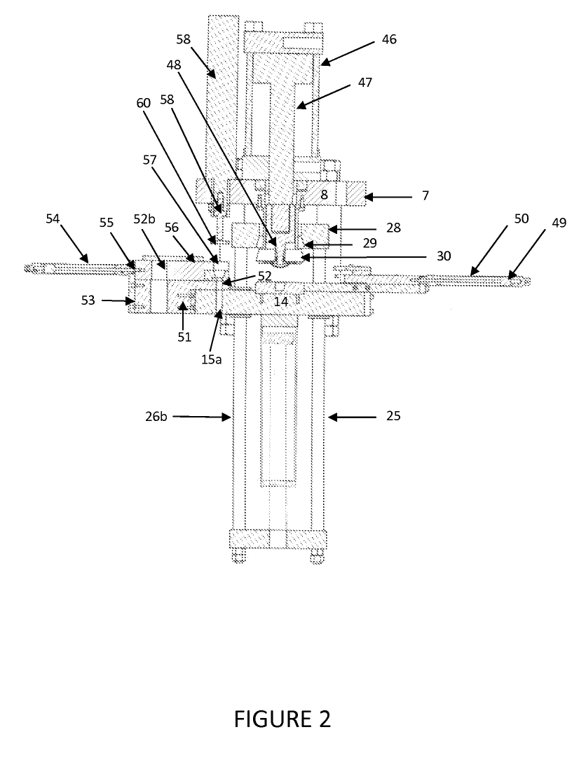

### DETAILED DESCRIPTION OF THE INVENTION

The apparatus for the manufacture of battery terminals of the present invention will be described in accordance with a preferred embodiment thereof and making reference to the accompanying drawings, wherein the same signs and numbers refer to the same elements.

The apparatus for the manufacture of battery terminals of the present invention comprises:

a support structure comprising:
a first vertical support post, a second vertical support post, a third vertical support post “1” and a fourth vertical support post “2” each having a first and a second end and each end having a thread portion having lesser diameter such that an annular bump portion is formed between the end of each support post and the thread portion;
a quadrangular shaped upper metallic plate “4”, having an upper surface “5”, a lower surface “6”, a frontal wall “7”, a back wall, a first lateral end “8”, a second lateral end “9”, four corner perforations, each located at a respective corner of the upper metallic plate “4”, each having a lesser diameter than the support posts, an aperture located at a central portion of the upper metallic plate “4”, and an opening located at a central portion near the back end, longitudinally centred;
a quadrangular shaped lower metallic plate “10”, having an upper surface “11”, a lower surface “12”, a frontal wall “13”, a back wall, a first lateral wall “14”, a second lateral wall “9”, four corner perforations, each located at a respective corner of the lower metallic plate “10”, each having a lesser diameter than the support posts, four perforations, each concentric with a respective corner perforation, and a passage “15a” located at a portion near the back end, longitudinally centred;
wherein the thread portions of the first end of each vertical support post, “4” tightly pass through a respective corner perforation of the upper metallic plate until the annular bump portion of each support post abuts the corresponding portion of the lower surface “6” of the upper metallic plate “4”, so that the upper metallic plate “4” is supported at the first end of the vertical support posts and part of the thread portion of the first end of each vertical support post protrudes above the upper surface “5” of the upper metallic plate “4”, and wherein the upper metallic plate “4” is fixed to the first end of each vertical support post by means of nuts “16” threaded into the protruding thread portions;
wherein the thread portions of the second end of each vertical support post, “4” tightly pass through a respective corner perforation of the lower metallic plate until the annular bump portion of each support post abuts the corresponding portion of the upper surface “11” of the lower metallic plate “10”, so that the lower metallic plate “10” serves as a support to the second end of the vertical support posts and part of the thread portion of the second end of each vertical support post protrudes below the lower surface “12” of the lower metallic plate “10”, and wherein the lower metallic plate “10” is fixed to the second end of each vertical support post by means of nuts “17” threaded into the protruding thread portions;
a circular shaped fixed die “18”, joined to a central portion of the upper surface “11” of the lower metallic plate “10”, having a central die housing “19”;
press means, for pressing a preform against the fixed die “18”, comprising:
   a metallic push plate “20” having an upper surface “21” and a lower surface “22”, and four corner perforations;
   a hydraulic press cylinder “23” joined to the lower surface “12” of the lower metallic plate “10” at a central portion thereof, and having a piston “24” whose end is directed downwards and which is joined to a central portion of the upper surface “21” of said metallic push plate “20”, wherein the hydraulic press cylinder “23” may push down or pull up the metallic push plate “20” thereby lowering or raising thereof;
   a first lineal guide bar “25”, a second lineal guide bar “26”, a third lineal guide bar “26b” and a fourth lineal guide bar “26b”, each having a first and a second end, wherein:
      the first end and the second end of each lineal guide bar have a thread portion;
      the thread portion of the second end of each lineal guide bar, passes through a corner perforation of the metallic push plate “20” in such way that part of each thread portion protrudes below the lower surface “22” of the metallic push plate “20” and each protruding thread portion receives a nut “27” thereby joining the metallic push plate “20” to each lineal guide bar, in such way that each lineal guide bar is vertically positioned over the metallic push plate “20”;
      the portion near the first end of each lineal guide bar, slidably passes through the concentric perforations of the lower metallic plate “10”, and protrude over the lower metallic plate “10”;
   a press plate “28”, comprising:
      an upper surface and a lower surface;
      a first lateral wall and a second lateral wall, a frontal wall and a back wall;
      a conic shaped central housing “29”, opened to the lower surface of the press plate “28” and having a perforation at a central portion thereof;
      four corner perforations, each located at a respective corner of the press plate “28”;
      wherein each press plate “28” corner perforation receive the thread portion of the first end of a corresponding lineal guide bar in such way that the press plate “28” is horizontally attached to the first end of each vertical support post by means of nuts threaded to the protruding thread portions, thereby joining the press plate “28” to the push plate “20” that is joined to the hydraulic press cylinder “23”, and wherein the press plate “28” is positioned between the upper metallic plate “4” and the lower metallic plate “10” of the support post;
      wherein the hydraulic press cylinder “23”, push or pull the push plate “20”, which in turn pull or push the lineal guide bars, which slide trough the concentric perforations of the lower metallic plate “10”, pushing or pressing the press plate “28” against the fixed die “18”;
   a moveable die structure, comprising:
      a first symmetric die portion “30” having a semi-circular shape, having an upper surface, a lower surface, a semi-circular lateral wall, a semi-circular semi-perforation located at a semi-central portion thereof, having a surrounding wall having the shape of the piece to be manufactured and a threaded housing “31” located at a central arch portion of the semi-circular lateral wall to be screwed to a first fastening structure “32” that joins said first die portion to the first lateral wall of the press plate “28”, in such way that the first die portion is attached below a half portion of the central housing “29” of the press plate “28”, and said first fastening structure allowing the second die portion to horizontally move, pushed by a hydraulic cylinder, and allowing the first die portion “30” to vertically move;
      a second symmetric die portion “33” having a semi-circular shape, having an upper surface, a lower surface, a semi-circular lateral wall, a semi-circular semi-perforation located at a semi-central portion thereof, having a surrounding wall having the shape of the piece to be manufactured and a threaded housing “34” located at a central arch portion of the semi-circular lateral wall to be screwed to a second fastening structure “35” that joins said second die portion to the second lateral wall of the press plate “28”, in such way that the second die portion is attached below a half portion of the central housing “29” of the press plate “28”, and said second fastening structure “35” allowing the second die portion to horizontally move, pushed by a hydraulic cylinder, to contact the first die portion “30”, which in turn is also horizontally moved at the same time, thereby closing the die structure which is formed by both die portions “30”, “33”, forming a central aperture whose walls have the shape of the piece to be manufactured, wherein the preform, is located at the same vertical axle with the central housing “29”, and wherein both die portions “30”, “33” can vertically move upwards or downwards, being housed in the central housing “29” when they move upwards;
      a first fastening structure “32” for the first die portion “30”, said first fastening structure “32” attached to a first lateral wall of the press plate “28” in such way that all the structure is able to move upwards and downwards together with the press plate “28”, thus allowing that the first die portion “30” can be moved upwardly and downwardly and additionally be horizontally moved either pushed or pulled by a hydraulic cylinder in order to open or close the die structure in cooperation with the second die portion “33”, said first fastening structure “32” comprising:
         a first fastening plate having:
         a frontal surface, a back surface, a first lateral wall, a second lateral wall, an upper wall and a lower wall;
         a rectangular cut, formed at a lower central portion of the first fastening plate, having lesser width than the width of the first fastening plate, leaving an horizontal upper bump wall where the cut begins;
         a quadrangular surface groove, formed at the back wall, beginning at the upper wall and ending where the rectangular cut begins;
         wherein the first fastening plate is attached to the first lateral wall of the press plate “28” by means of four bolts, in such way that: its back wall contacts the first lateral wall of the press plate “28”, forming a closed passing groove with the surface groove of the first fastening plate and with the surface of the first lateral wall of the press plate “28”;
         a first vertical metallic member comprising a quadrangular metallic plate, having a first vertical surface and a second vertical surface, a first vertical longitudinal lateral wall, a second vertical longitudinal lateral wall, a horizontal upper wall and a horizontal lower wall, a perforation located a central portion thereof and two equidistant threaded housings located at the horizontal upper wall, said quadrangular metallic plate being housed in the passing groove formed between the first fastening plate in such way that it can slide upwards and downwards with respect to the press plate “28”, wherein a pair of horizontal washers screwed to a respective threaded housing, avoid that said quadrangular metallic plate slide downwards out of the passing groove when the washers bump with the upper wall of the first fastening plate;
         a first horizontal metallic member, comprising a horizontal metallic block having an upper wall, a lower wall, a first lateral wall, a second lateral wall, a frontal wall and a back wall, said first horizontal metallic member having lesser width than the width of the first vertical metallic member, and having a horizontal longitudinal tunnel located at a central portion thereof beginning at the frontal wall and ending at the back wall, wherein the frontal wall of said first horizontal metallic member is attached to the first vertical surface of the first vertical metallic member at a lower central portion thereof, in such way that the horizontal tunnel coincides with the perforation located at a central portion of the first vertical metallic member, showing a first joining surface and a second joining surface, each having a rectangular surface over the first vertical surface at both sides of the first horizontal metallic member and in such way that the horizontal metallic block moves upwards or downwards together with the first vertical metallic member along the space left by the quadrangular cut formed at a central lower portion of the fastening plate, and wherein a corresponding end of the upper wall, bumps with the horizontal upper bump wall formed by the quadrangular cut of the first fastening plate when moving upwards, thus avoiding that the first vertical metallic member and first horizontal metallic member to excessively slide upwards in such way that the first vertical metallic member slides out of the passing groove;
         a first horizontal fastening arm “36” having a first threaded end and a second end having a clamp receiving portion to connect with a piston of a first die pneumatic cylinder “37”, said first horizontal fastening arm “36” slidably passing through the perforation of the first vertical metallic member and trough the horizontal longitudinal tunnel, and connected to the threaded housing “31 of the first symmetric die portion “30” by its first threaded end, thereby connecting said first symmetric die portion “30” to the first fastening structure “32” in such way that said die portion “30” is able to move upwards and downwards and move horizontally pushed by the first pneumatic cylinder “37” connected to the second end of the first horizontal fastening arm “36”;
         a second fastening structure “35” for the second symmetric die portion “33”, said second fastening structure “35” attached to the second lateral wall of the press plate “28” in such way that all the second fastening structure “35” can move upwards and downwards together with the press plate “28”, thus allowing the second symmetric die portion “33” to be moved upwards and downwards and additionally, to be horizontally moved, pushed or pulled by a hydraulic cylinder for opening or closing the die structure by cooperating with the first die portion “30”, said second fastening structure “35” comprising:
         a second fastening plate having:
         a first frontal surface, a back surface, a first lateral wall, a second lateral wall, an upper wall and a lower wall;
         a quadrangular cut formed at a lower central portion of the second fastening plate having lesser width than the width of the second fastening plate, showing a horizontal upper bump wall where the cut begins;
         a quadrangular superficial groove formed at the back portion, beginning at the upper wall and ending where the quadrangular cut begins;
         wherein the second fastening plate is joined to the second lateral wall of the press plate “28” by means of four bolts, in such way that: its back wall contacts the second lateral wall of the press plate, thus forming a closed passing groove in cooperation with the surface groove of the second fastening plate and with the surface of the second lateral wall of the press plate “28”;
         a second vertical metallic member comprising a quadrangular metallic plate, having a first vertical surface and a second vertical surface, a first longitudinal vertical lateral wall, a second longitudinal vertical lateral wall, an upper horizontal wall and a lower horizontal wall, a perforation located at a central portion thereof and two equidistant threaded housings located at the horizontal upper wall, said quadrangular metallic plate being housed in the passing groove formed between the second fastening plate in such way that it can slide upwards and downwards with respect to the press plate “28”, wherein a pair of horizontal washers screwed to a respective threaded housing avoid that said quadrangular metallic plate slides downwards out of the passing groove when said washers bump with the upper wall of the second fastening plate;
         a second horizontal metallic member comprising a horizontal metallic block having a upper wall, a lower wall, a first lateral wall, a second lateral wall, a frontal wall and a lower wall and having lesser width than the width of the vertical metallic member, having a longitudinal horizontal tunnel located at a central portion thereof, beginning at the frontal wall and ending at the back wall, wherein the frontal wall of said second horizontal metallic member is joined to the second vertical surface of the second horizontal metallic member at a lower central portion thereof in such way that the horizontal tunnel coincide with the perforation located at a central portion of the second horizontal metallic member, showing a first joining surface and a second joining surface, each having a rectangular shape, both located over the first vertical surface at both sides of the second horizontal metallic member in such way that the horizontal metallic block moves upwards or downwards together with the second horizontal metallic member along the space left by the quadrangular cut formed at a lower central portion of the second fastening plate, and wherein a corresponding end of the upper wall bumps with the horizontal upper bump wall formed by the quadrangular cut of the second fastening plate when it moves upwards, thus avoiding the second vertical metallic member and the second horizontal metallic member to excessively slide upward in such way that the vertical metallic member slides out of the passing groove;
      a second horizontal fastening arm “38”, having a first threaded end and a second threaded end having a first joining surface and a second joining surface for receiving a clamp to connect with a piston of a second die pneumatic cylinder “39”, said second horizontal fastening arm “38” slidably passing through the perforation of the second vertical metallic member and trough the horizontal longitudinal tunnel, and connected to the threaded housing “34” of the second symmetric die portion “33” by its first threaded end, thereby connecting said second symmetric die portion “33” to the second fastening structure “35” in such way that said die portion “33” is able to move upwards and downwards and move horizontally pushed by the second pneumatic cylinder “39” connected to the second end of the second horizontal fastening arm “38”;
   a first support structure “40” for the first pneumatic cylinder “37”, comprising:
      a first longitudinal support member comprising an elongated rectangular beam having first end and a second end, a first lateral surface, a second lateral surface, a frontal surface located at the first end and a back surface located at the second end, wherein the frontal surface is joined to the first joining surface over the first vertical surface of the first horizontal metallic member of the first fastening structure “32” occupying all of said joining surface in such way that a portion of the second lateral surface near the first end of the rectangular beam, contacts the first lateral wall of the first horizontal metallic member of the first fastening structure “32”;
      a second longitudinal support member comprising an elongated rectangular beam having first end and a second end, a first lateral surface, a second lateral surface, a frontal surface located at the first end and a back surface located at the second end, wherein the frontal surface is joined to the second joining surface over the first vertical surface of the first horizontal metallic member of the first fastening structure “32” occupying all of said joining surface in such way that a portion of the second lateral surface near the first end of the rectangular beam, contacts the first lateral wall of the first horizontal metallic member of the first fastening structure “32”;
      a transversal support member comprising an elongated rectangular shaped member having a first end, a second end, a frontal wall, a back wall and a circular shaped passage located at a central portion thereof, wherein said transversal support member is transversally joined to the back walls of the first longitudinal support member and of the second longitudinal support member by means of bolts;
   a first die pneumatic cylinder “37”, joined to the frontal surface of the transversal support member of the first support structure “40”, and having a piston “41”, wherein said piston “42” passes through the passage of the transversal support member and having a clamp at its end “42”, which loosely connects to the clamp receiving portion of the first horizontal fastening arm, thereby joining the first pneumatic cylinder “37” with the first die portion “30” and wherein the first pneumatic cylinder “37” pulls or pushes the first die portion “30” for opening of closing the die structure cooperating with the second die structure “33”, and wherein the loose joint between the clamp “42” and the clamp receiving portion, avoid excessive tensions during the operation of the press means;
      a second support structure “SU” for the second pneumatic cylinder “39”, comprising:
      a first longitudinal support member comprising an elongated rectangular beam having first end and a second end, a first lateral surface, a second lateral surface, a frontal surface located at the first end and a back surface located at the second end, wherein the frontal surface is joined to the first joining surface over the first vertical surface of the second horizontal metallic member of the second fastening structure “35” occupying all of said joining surface in such way that a portion of the second lateral surface near the first end of the rectangular beam, contacts the first lateral wall of the second horizontal metallic member of the second fastening structure “35”;
      a second longitudinal support member comprising an elongated rectangular beam having first end and a second end, a first lateral surface, a second lateral surface, a frontal surface located at the first end and a back surface located at the second end, wherein the frontal surface is joined to the second joining surface over the first vertical surface of the second horizontal metallic member of the second fastening structure “35” occupying all of said joining surface in such way that a portion of the second lateral surface near the first end of the rectangular beam, contacts the second lateral wall of the second horizontal metallic member of the second fastening structure “35”;
      a transversal support member comprising an elongated rectangular shaped member having a first end, a second end, a frontal wall, a back wall and a circular shaped passage located at a central portion thereof, wherein said transversal support member is transversally joined to the back walls of the first longitudinal support member and of the second longitudinal support member by means of bolts;
   a second die pneumatic cylinder “39”, joined to the frontal surface of the transversal support member of the second support structure “SU”, and having a piston “43”, wherein said piston “43” passes through the passage of the transversal support member and having a clamp “44” at its end “42”, which loosely connects to the clamp receiving portion of the second horizontal fastening arm “38”, thereby joining the second pneumatic cylinder “39” with the second die portion “33” and wherein the second pneumatic cylinder “39” pulls or pushes the second die portion “33” for opening of closing the die structure cooperating with the first die structure “30”, and wherein the loose joint between the clamp “44” and the clamp receiving portion, avoid excessive tensions during the operation of the press means;
punching means, comprising:
   a hydraulic punching cylinder “46” having a piston “47”;
   an elongated punching member “48” joined to the piston “47” of the hydraulic cylinder “46”;
   wherein the hydraulic punching cylinder “46” is joined to the upper surface “5” of the upper metallic plate “4” of the support structure; wherein the elongated punching member “48” is pushed by the hydraulic punching cylinder “46” through the aperture of the upper metallic plate “4” and trough the central perforation of the closed die structure comprised by both die portions, for entering in the central die housing “19” of the circular shaped fixed die “18”;
means for providing a preform to the press means, said preform made from a malleable metallic material, preferably lead, wherein the means for providing a preform comprising:
   a preform pneumatic feeding cylinder “49” having a piston “50”;
   a vertical stacker tube, for vertically stacking a plurality of preforms, said stacker tube ending at a preform reception section;
   a preform feeding arm having a first end and a second end, wherein the first end is joined to the preform pneumatic feeding cylinder “49” and the second end has a preform clamping section that coincides with the end of the vertical stacker tube when the piston “50” of the preform pneumatic feeding cylinder “49” is at the beginning of its displacement;
   a support structure for the preform feeding arm, comprising a horizontal plate, wherein one of the ends thereof is in contact with the central die housing “19” and adapts to said central die housing “19” in such way that said horizontal plate show a surface that is located at the same level as the surface of the surface of the central die housing “19”, wherein said horizontal plate has an upper surface that supports the preform feeding arm and over which the preform feeding arm can slide, wherein said support structure is joined to the upper surface “5” of the lower metallic plate “10”;
   wherein the piston “50” of the of the preform pneumatic feeding cylinder “49” pushes the preform feeding arm until the preform clamping section coincides with the central die housing “19” of the circular shaped fixed die “18” so that the preform can fall by gravity over said central die housing “19”;
means for receiving a partially formed piece from the movable die structure, comprising:
   support means comprising a “L” shaped polygonal metallic member “51”, having:
      a main portion and an elongated secondary portion depending from the main portion;
      a main straight wall;
      a base wall (the base of the “L”);
      an “L” shaped coupling wall; and
      a passage “52” located at the secondary portion;
      wherein the support means are joined to the lower metallic plate “10” in such way that the “L” shaped coupling wall joins to the back wall of the lower metallic plate “10” in such way that the base wall is vertically disposed, the main portion is located over the upper surface of the “L” shaped coupling wall and the main straight wall is horizontally disposed;
   a joining plate “53” for a pneumatic cylinder “54” for reception means, having a frontal surface and a back surface, wherein the frontal surface is joined to the base wall in such way that a portion of the joining plate protrudes over the main surface of the support means, said protruding portion having a passage “55”;
   a pneumatic cylinder for reception means of partially formed pieces, joined to the back surface of the joining plate “53”, wherein the piston passes through the passage “55” of said joining plate “53”;
   reception means of formed pieces, comprising a rectangular shaped reception member “56”, having:
      a first longitudinal end and a second longitudinal end;
      an upper surface and a lower surface;
      a frontal wall and a back wall;
      a conic cavity “57” for receiving formed pieces located at the first longitudinal end;
      a passage “58” located at a portion near the second longitudinal end;
      wherein the back wall is joined to the piston of the pneumatic cylinder for reception means of partially formed pieces “54” for pulling or pushing the rectangular shaped reception member “56”, which is disposed over the main straight wall of the “L” shaped polygonal metallic member “51” of the support member in such way that it slides over said main straight wall pulled or pushed by said pneumatic cylinder for reception means of partially formed pieces “54”;
      wherein the pneumatic cylinder for reception means of partially formed pieces “54” pushes the rectangular shaped reception member “56” until the conic cavity “57” coincides with the central aperture of the closed die structure when it is at an elevated position over the fixed die “18”, in such way that it can receive a formed piece when the central perforation of the closed die holds a formed piece and it opens, thus dropping the formed piece in said conic cavity “57”; and
      wherein the passage “52 of the reception means coincides with the passage “15a” of the lower metallic plate “10” when the pneumatic cylinder for reception means of partially formed pieces “54” pushes the reception member “56” until the conic cavity “57” coincide with the central perforation of the closed die structure, thereby forming a single passage completely crossing the lower metallic plate “10” and the support means “51”;
perforating means comprising:
   a hydraulic piercing cylinder “58” having a piston “59”, said piston having a piercing member at its end;
   wherein the hydraulic piercing cylinder “58” is joined to the upper surface “5” of the upper metallic plate “4” of the support structure, and the piston “59” passes through the aperture located at a portion near the back portion of the upper metallic plate “4” in such way that the piercing member coincides with the conic cavity “57” of the reception means of formed pieces, passing aside the metallic push plate “20” of the press means, being pushed towards the conic cavity “57” for piercing a semi formed piece placed in said conic cavity “57”; and wherein the piston “59” together with the piercing member are pulled upwards once the piercing member perforates the formed piece, leaving the formed piece releasable coupled to the piercing member;
means for decoupling a punched formed piece from the piercing member, comprising:
   a fixed upper plate “60”, joined to an upper portion of the piston “59” of the hydraulic piercing cylinder “58”, located below the lower surface “6” of the upper metallic plate “4” of the support structure alongside the push metallic plate “20” of the press means, said fixed upper plate “60” having two equidistant perforations longitudinally located following a collinear axle with the end of the metallic push plate “20”;
   a lower movable plate, attached to the upper fixed plate “60”, located immediately below the fixed upper plate “60” and in front of the piercing member, two bolts joined to the upper surface, each passing through one of the equidistant perforations of the upper fixed plate “60”, in such way that an upper portion of each bolt, and the head of each bolt is located over the upper surface of the fixed upper plate “60” and immediately below the lower surface of the upper metal plate “4” of the support structure, and in such way that each bolt can slide trough said equidistant perforations, thus allowing that the lower movable plate can be moved upwards or downwards;
   a first spring and a second spring, each having a first and a second end, and each coiled around the upper portion of a corresponding bolt, each one located between the upper surface of the fixed upper plate and the head of the corresponding bolt; and
   wherein the first end of each spring contacts the head of a corresponding bolt, and the second end of each spring contacts the upper surface; and
   wherein said first and second spring avoid that the movable lower plate slide downwards, because when the weight thereof pulls each bolt downwards, the head of each bolt tries to compress a corresponding bolt against the upper surface of the upper fixed plate, and each spring exerts an elastic force upwards over the head of the corresponding bolt, thus maintaining the upper portion of each bolt over the surface of the upper fixed plate “60”;
wherein the means for decoupling a punched formed piece from the piercing member, move upwards and downwards together with the piston of the hydraulic piercing cylinder “58”, in such way that when the punching means finish perforating a preformed piece and said piece ends releasably coupled to the piercing member, the hydraulic piercing cylinder “58” moves the piston “59”, the means for decoupling a punched formed piece upwards until the heads of each bolt contact the lower surface “6” of the upper metallic plate “4” and maintain the lower movable plate at a fixed vertical position while the upper fixed plate “60” slides guided by the bolts and moves upwards together with the piston “59” and with the piercing member, until the periphery of the pierced piece that is moving upwards together with the piercing member, bumps with the lower surface of the movable lower plate while the piercing member move upwards, thus allowing the pierced piece to decouple from the piercing member and fall by gravity to the ground or to a finished pieces container, through the passage formed when the passage “52” of the reception member “56” coincides with the passage “15a” of the lower plate “10” and with the passage “52”;
electronic control means connected to a set of connected hydraulic controllers, for controlling the press hydraulic cylinder “23”, the first pneumatic cylinder “37”, the second pneumatic cylinder “39”; the hydraulic punching cylinder “46”, the preform pneumatic feeding cylinder “49”, the pneumatic cylinder for reception means of partially formed pieces “54” and the hydraulic piercing cylinder “58”;
wherein the piston of each pneumatic cylinder is magnetic;
means for detecting the position of each pneumatic cylinder comprising:
   a beginning of displacement sensor and an end of displacement sensor for the first pneumatic cylinder “37”, each located at the body of the pneumatic cylinder;
   a beginning of displacement sensor and an end of displacement sensor for the second pneumatic cylinder “39”, each located at the body of the pneumatic cylinder;
   a beginning of displacement sensor and an end of displacement sensor for the preform pneumatic feeding cylinder “49”, each located at the body of the pneumatic cylinder;
   a beginning of displacement sensor and an end of displacement sensor for the pneumatic cylinder for reception means of partially formed pieces “54”, each located at the body of the pneumatic cylinder;
   wherein each sensor is connected to the electronic control means;
means for detecting the position of the hydraulic piercing cylinder “58” comprising: a start of displacement inductive proximity sensor, a middle of displacement inductive proximity sensor, and an end of displacement inductive proximity sensor, each one connected to the electronic control means, and each located at a vertical bar attached between upper metallic plate and the lower metallic plate, each sensor sensing a detectable element attached to the fixed lower plate of the means for decoupling a punched formed piece as the hydraulic piercing cylinder “58” moves upwards and downwards;
means for detecting the position of piston of the hydraulic press cylinder “23”, comprising:
a start of displacement inductive proximity sensor, a middle displacement inductive proximity sensor, an end of displacement inductive proximity sensor, each one connected to the electronic control means and each located at the body of the hydraulic cylinder;
a first detectable element attached to the first lineal guide bar “25”, located at a place that corresponds to the beginning of displacement of the piston of the hydraulic press cylinder “23”, and a second detectable element attached to the first lineal guide bar “25”, located at a place that corresponds to the end of displacement of the piston of the hydraulic press cylinder “23”;
means for detecting the position of the piston “47” of the hydraulic punching cylinder “46”, comprising a beginning of displacement pressure sensor, and an end of displacement pressure sensor, each one connected to the electronic control means and each attached to the oil inlet/outlet port of the piston of the hydraulic punching cylinder respectively, said sensors able to be regulated and detecting when the internal pressure of the internal cavities of the hydraulic punching cylinder “46” raise until a predetermined value, in such way that when the piston “47” of the hydraulic punching cylinder “46” ends punching a piece, the internal pressure rises to 3000 psi, which is detected by the end of displacement pressure sensor and is interpreted by the electronic control means as the end of displacement for the piston of the hydraulic punching cylinder “46”. When the piston “47” of the hydraulic punching cylinder “46” retracts to its initial position of beginning of displacement, the internal pressure decreases to a predetermined value, which, in a preferred embodiment if of between 700 and 1000 psi which indicates than the piston “47” reached the beginning of its displacement, since the internal pressure decreases at the oil inlet which causes the piston to retract, which is detected by the beginning of displacement pressure sensor and is interpreted by the electronic control means as the beginning of displacement for the piston “47”;
means for detecting a preform for providing it to the vertical stacker tube, said means for detecting a preform, connected to the electronic control means, comprising:
   means for emitting a light beam, located at the lower end of the vertical stacker tube;
   an optical sensor, located at the lower end of the vertical stacker tube, opposed to the means for emitting a light beam;
   wherein any preform ready to be provided, stands between means for emitting a light beam and the optic sensor, thus causing that the optic sensor stops receiving the light beam, which is interpreted by the electronic control means that a preform is ready to be provided;

In other embodiments, the means for decoupling a formed piece from the piercing member may comprise any other means that provide the same function and that are less complicated. For example, it is possible to use a punching hydraulic piston having a plunger that is thinner than the external diameter of the formed piece, in such way, the means for decoupling the formed piece would be comprised only by a fixed plate having a central bore by which the plunge of the piston of the hydraulic punching cylinder may freely pass, but not the finished piece, therefore, when said piston is completely retracted, the finished piece contacts the plate and is retained there, thus decoupling said finished piece from the piercing member as it moves upwards.

The hydraulic press cylinder “23” may exert a maximum pressure of 26.75 tons (which are used to form the piece). The minimum pressure that the hydraulic press cylinder “23” may exert before forming defective pieces is approximately 4.5 tons.

The electronic control means run a machine control method for manufacturing battery terminals which is stored in memory means, wherein the control method begins an execution cycle with an initial machine status comprising:
i) Press plate “28” is at an elevated position;
ii) The piston “24” of the hydraulic press cylinder “23” is at a retracted position;
iii) The first and second symmetric die portions “30”, “33” are separated, the die structure is opened and out of the conic shaped central housing “29” of the press plate and under the lower surface of the press plate “28”;
iv) The piston “41” of the first die pneumatic cylinder “37” and the piston 43 of the second die pneumatic cylinder “39” are at a retracted position;
v) The piston “47” of the hydraulic punching cylinder is at a retracted position;
vi) The piston “50” of the preform pneumatic feeding cylinder “49” is at a retracted position;
vii) The preform clamping section of the preform feeding arm coincides with the end of the vertical stacking tube;
viii) The piston of the pneumatic cylinder for reception means of partially formed pieces “54” is at a retracted position;
ix) The conic cavity “57” for receiving formed pieces of the rectangular shaped reception member “56” coincides with the piercing member of the piston “59” of the hydraulic piercing cylinder “58”.
x) The piston “59” of the hydraulic piercing cylinder “58”, is at the middle of its displacement or at a partial displacement;
xi) The piercing member is at an upper position;
xii) The heads of the first bolt and the second bolt that are joined to the upper surface of the lower movable plate of the means for decoupling a pierced piece from the piercing member, are separated from the lower surface of the upper metallic plate “4” of the support structure;
   wherein the machine control method for manufacturing battery terminals comprises the following steps:
   a) detecting if there is a preform to be processed in the vertical stack tube, if so, proceed to next stage;
   b) activate the preform pneumatic feeding cylinder “49” for extending its piston “50” and pushing the feeding arm until the piston “50” of the preform pneumatic feeding cylinder “49” reaches an extended position and until the preform clamping section coincides with the central die housing “19” of the circular shaped fixed die “18” and let the preform fall over said central die housing “19” by gravity;
   c) activate the preform pneumatic feeding cylinder “49” for retracting its piston “50”, when it is detected that the piston “50” of the preform pneumatic feeding cylinder “49” has reached end of displacement so that it pulls the feeding arm until the piston “50” of the preform pneumatic feeding cylinder “49” returns to a retracted position and until the preform clamping section coincides again with the end of the vertical stacking tube;
   d) activate the first die pneumatic cylinder “37” and the second die pneumatic cylinder for extending their respective pistons once it has been detected that the piston of the preform pneumatic feeding cylinder “49” reaches beginning of displacement, so that both pistons “37” and “39” push a corresponding horizontal fastening arm in order to horizontally move the die portions “30”, “33” until its respective pistons reach an end of displacement extended position and close the die structure;
   e) activate the hydraulic press cylinder “23” for extending its piston once it has been detected that both the piston of the first die pneumatic cylinder “37” and the second die pneumatic cylinder reach end of displacement, so that the piston of the hydraulic press cylinder “23” pushes the metallic push plate “20” downwards to pull the press plate “28” together with the closed die structure downwards until the closed die structure enters the conic shaped central housing “29” of the press plate “28” and is pressed against the circular shaped fixed die “18” having a preform inside the central die housing “19” in such way that the preform enters in the central die housing “19” of the closed die structure;
   f) activate the hydraulic punching cylinder “46” for extending its piston “47”, once it is detected that the piston of the hydraulic press cylinder “23” reaches end of displacement, so that the piston “47” of the hydraulic punching cylinder “46” pushes the piercing member through the aperture of the metallic upper plate “4” and trough the central perforation of the closed die structure comprised by both die portions “30”, “33” until the piercing member enters in the central die housing “19” of the circular shaped fixed die “18” and press the preform against the walls of the central aperture of the closed die structure and against the walls of the central die housing “19” in order to form a partially formed piece having a central cavity, wherein the partially formed piece is retained in the central aperture of the die structure;
   g) activate the hydraulic punching cylinder “46” for retracting its piston “47” until reaching mid of displacement position once it is detected that the piston “47” of the hydraulic punching cylinder “46” has reached end of displacement;
   h) activate the press hydraulic cylinder “23” for retracting its piston “24” until reaching beginning of displacement once it is detected that the piston “47” of the hydraulic punching cylinder “46” reaches beginning of displacement so that the piston “24” of the hydraulic cylinder “23” pulls the metallic push plate “20” upwards, to push the press plate “28” together with the closed die structure (having the partially formed piece retained inside its central aperture) upwards to an initial elevated position and to pull the closed die structure out from the conic cavity “57” of the press plate, wherein when the closed die structure moves upwards together with the partially formed piece, causes that the central cavity thereof comes near the elongated punching member “48” in such way that the elongated punching member “48” loosely enters in the central cavity of the partially formed piece;
   i) activate the pneumatic cylinder for reception means of partially formed pieces “54” for extending its piston until reaching end of displacement once it is detected that the piston “24” of the hydraulic press cylinder “23” reaches beginning of displacement, in order to push the reception means until the conic cavity “57” for receiving formed pieces, coincides with the central aperture of the closed die structure and until the passage “52” of the support means of the means for receiving a partially formed piece, coincides with the passage 15a″ of the inferior metallic plate “10” and with the passage “52 of the reception means, thereby forming a single passage completely crossing the lower metal plate “10” and the support means;
   j) activate the hydraulic piercing cylinder “58” for retracting its piston “59” until reaching beginning of displacement and moving the means for decoupling a punched formed piece from the piercing member upwards for decoupling any formed piece from the piercing member, until the heads of each bolt of the means for decoupling contact the lower surface of the upper fixed plate “60” and maintain the lower movable plate at a fixed vertical position while the upper fixed plate “60” slides guided by the bolts and moves upwards together with the piston “59” and with the piercing member, until the periphery of the pierced piece that is moving upwards together with the piercing member, bumps with the lower surface of the movable lower plate while the piercing member move upwards, thus allowing the pierced piece to decouple from the piercing member and fall by gravity to the ground or to a finished pieces container, through the passage formed when the passage “52” of the reception member “56” coincides with the passage “15a” of the lower plate “10” and with the passage “52”;
   k) activate the pneumatic die cylinder “37” die and the second die pneumatic cylinder “39” for retracting its respective pistons “41”, “43” until beginning of displacement once it is detected that the piston of the pneumatic cylinder for reception means of partially formed pieces “54” reaches end of displacement in order to pull a corresponding horizontal fastening arm “36” and horizontally move the die portions “30”, “33” until its respective pistons reach beginning of displacement and open the die structure thus releasing the partially formed piece, dropping it in the conic cavity “57” for receiving formed pieces, wherein before the die structure is opened, the piercing member is loosely housed inside the cavity of the partially formed piece, by which it is avoided that the partially formed piece remains coupled to a die portion when the die structure is opened, since the piercing member maintains the partially formed piece at a central position;
   l) activate the pneumatic cylinder for reception means of partially formed pieces “54” for retracting its piston until reaching beginning of displacement once it is detected that the first die pneumatic cylinder “37” and the second die pneumatic cylinder “39” reach beginning of displacement in order to pull the reception means until the conic cavity “57” having the partially formed piece coincide with the piercing member at the same vertical axle;
   m) activate the hydraulic piercing cylinder “58” for extending its piston “59” until reaching end of displacement once it is detected that the piston of the pneumatic cylinder for reception means of partially formed pieces “54” reach beginning of displacement in order to push the piercing means towards the conic cavity “57” in order to perforate a piece located inside said conic cavity “57”;
   n) activate the hydraulic piercing cylinder “58” for retracting its piston “59” and the piercing means having the formed piece coupled thereto until reaching partial displacement, once it is detected that the piston “59” reaches end of displacement, in order to put said piercing means in position for decoupling the formed piece from the piercing means when another execution cycle of the control method is repeated and step i) is carried out.

In other embodiments of the present invention, the means for decoupling a formed piece from the piercing means may comprise any suitable means capable of carrying out the same function. For example, it is possible to use the piston of a hydraulic piercing cylinder having a plunger that is thinner than the external diameter of the formed piece. In this way, the means for decoupling a formed piece may comprise only a fixed plate having a central hole through which the plunger of the piston of the hydraulic piercing cylinder may freely pass, except the formed piece, so that when the piston of the hydraulic piercing cylinder is retracted, the formed piece bumps with the fixed plate and is thus decoupled from the piercing means as the piston is retracted.

The hydraulic press cylinder “23” may exert a maximum force of 26.75 tons (which are used to press form the piece). The minimum piece that it can exert without press forming the piece is 4.5 tons.

By using the apparatus and method of the present invention, is possible to manufacture two kinds of pieces one kind of piece denominated as “big” and a second kind of smaller piece denominated “small” piece. For manufacturing the big piece, it is necessary to provide a volume of material of approximately 4.839 cm3, whereas for manufacturing the small piece, it is necessary to provide a volume of material of approximately 4.035 cm3.

Although it was described the use of hydraulic and pneumatic cylinders, it has to be understood that in other embodiments of the invention they may be used any kind of suitable means for exerting a force and for moving the forming elements, such as electric motors.

It should be finally understood that the apparatus and method for the manufacture of battery terminals of the present invention, is not limited to the embodiments formerly described and that the persons skilled in the art will be able, by the teachings herein disclosed, to carry out changes in the apparatus and method for the manufacture of battery terminals, of the present invention, which will be within the true scope of the invention, which will be set forth exclusively by the following claims.

1. Apparatus for the manufacture of battery terminals from a metallic preform, comprising:
a support structure
a fixed die, joined to the support structure, having a cavity for receiving the metallic preform;
a moveable die structure, for pressing the metallic preform against the fixed die, said movable structure comprising:
a press plate having an open housing;
a die structure comprising at least two die portions that can be opened or closed, said die structure able to move closer or farther with respect to the press plate, said die structure:
when closed, forming a cavity opened by its upper and lower portion having one or more walls forming the shape of a piece to be formed and being able to enter in the open housing of the press plate when pressed against the fixed die, in such way that the cavity of the fixed die is aligned with the cavity formed when the die structure is closed and in such way that the metallic preform enters said cavity when the closed die structure is pressed against the fixed die thus entering the open housing of the press plate;
returning to an open state when it exits the open housing of the press plate after it was pressed against said press plate in order to liberate a partially formed piece; and
punching means joined to the support structure, said punching means pushed through the open housing of the press plate and entering the cavity formed when the die structure is closed in such way that it presses the metallic preform against the one or more walls of said cavity and against the cavity of the fixed die, thus forming a hollow metallic piece having a lower wall.

2. The apparatus for the manufacture of battery terminals as claimed in claim 1, additionally comprising means for providing a metallic preform to the fixed die.

3. The apparatus for the manufacture of battery terminals as claimed in claim 1, additionally comprising means for receiving partially formed piece, for receiving a partially formed piece when the die structure is opened and provide said partially formed piece to the punching means.

4. The apparatus for the manufacture of battery terminals as claimed in claim 1, additionally comprising means for receiving partially formed piece, for receiving a partially formed piece when the die structure is opened and provide said partially formed piece to the punching means, said means for receiving partially formed piece comprising an elongated metallic member having a housing for receiving the partially formed piece, said housing supporting the partially formed piece when perforated by perforating means.

5. The apparatus for the manufacture of battery terminals as claimed in claim 1, wherein the support structure comprising:
a first vertical support post, a second vertical support post, a third vertical support post and a fourth vertical support post each having a first and a second end and each end having a thread portion having lesser diameter such that an annular bump portion is formed between the end of each support post and the thread portion;
a quadrangular shaped upper metallic plate, having an upper surface, a lower surface, a frontal wall, a back wall, a first lateral end, a second lateral end, four corner perforations, each located at a respective corner of the upper metallic plate, each having a lesser diameter than the support posts, an aperture located at a central portion of the upper metallic plate, and an opening located at a central portion near the back end, longitudinally centred;
a quadrangular shaped lower metallic plate, having an upper surface, a lower surface, a frontal wall, a back wall, a first lateral wall, a second lateral wall, four corner perforations, each located at a respective corner of the lower metallic plate, each having a lesser diameter than the support posts, four perforations, each concentric with a respective corner perforation, and a passage located at a portion near the back end, longitudinally centred;
wherein the thread portions of the first end of each vertical support post, tightly pass through a respective corner perforation of the upper metallic plate until the annular bump portion of each support post abuts the corresponding portion of the lower surface of the upper metallic plate, so that the upper metallic plate is supported at the first end of the vertical support posts and part of the thread portion of the first end of each vertical support post protrudes above the upper surface of the upper metallic plate, and wherein the upper metallic plate is fixed to the first end of each vertical support post by means of nuts threaded into the protruding thread portions;
wherein the thread portions of the second end of each vertical support post, tightly pass through a respective corner perforation of the lower metallic plate until the annular bump portion of each support post abuts the corresponding portion of the upper surface of the lower metallic plate, so that the lower metallic plate serves as a support to the second end of the vertical support posts and part of the thread portion of the second end of each vertical support post protrudes below the lower surface of the lower metallic plate, and wherein the lower metallic plate is fixed to the second end of each vertical support post by means of nuts threaded into the protruding thread portions.

6. The apparatus for the manufacture of battery terminals as claimed in claim 5, wherein the fixed die has a circular shape and a central die housing, said fixed die joined to a central portion of the upper surface of the quadrangular shaped lower metallic plate.

7. The apparatus for the manufacture of battery terminals as claimed in claim 5, wherein the press plate is moved by means of a press means comprising:
a metallic push plate having an upper surface and a lower surface, and four corner perforations;
a hydraulic press cylinder joined to the lower surface of the lower metallic plate at a central portion thereof, and having a piston whose end is directed downwards and which is joined to a central portion of the upper surface of said metallic push plate, wherein the hydraulic press cylinder may push down or pull up the metallic push plate thereby lowering or raising thereof;
a first lineal guide bar, a second lineal guide bar, a third lineal guide bar “and a fourth lineal guide bar, each having a first and a second end, wherein:
the first end and the second end of each lineal guide bar have a thread portion;
the thread portion of the second end of each lineal guide bar, passes through a corner perforation of the metallic push plate in such way that part of each thread portion protrudes below the lower surface of the metallic push plate and each protruding thread portion receives a nut thereby joining the metallic push plate to each lineal guide bar, in such way that each lineal guide bar is vertically positioned over the metallic push plate; and
the portion near the first end of each lineal guide bar, slidably passes through the concentric perforations of the lower metallic plate, and protrude over the lower metallic plate.

8. The apparatus for the manufacture of battery terminals as claimed in claim 5, wherein the press plate comprising:
an upper surface and a lower surface;
a first lateral wall and a second lateral wall, a frontal wall and a back wall;
a conic shaped central housing, opened to the lower surface of the press plate and having a perforation at a central portion thereof; and
four corner perforations, each located at a respective corner of the press plate.

9. The apparatus for the manufacture of battery terminals as claimed in claim 8, wherein the die structure comprising:
a first symmetric die portion having a semi-circular shape, having an upper surface, a lower surface, a semi-circular lateral wall, a semi-circular semi-perforation located at a semi-central portion thereof, having a surrounding wall having the shape of the piece to be manufactured and a threaded housing located at a central arch portion of the semi-circular lateral wall to be screwed to a first fastening structure that joins said first die portion to the first lateral wall of the press plate, in such way that the first die portion is attached below a half portion of the central housing of the press plate, and said first fastening structure allowing the second die portion to horizontally move, pushed by a hydraulic cylinder, and allowing the first die portion to vertically move; and
a second symmetric die portion having a semi-circular shape, having an upper surface, a lower surface, a semi-circular lateral wall, a semi-circular semi-perforation located at a semi-central portion thereof, having a surrounding wall having the shape of the piece to be manufactured and a threaded housing located at a central arch portion of the semi-circular lateral wall to be screwed to a second fastening structure that joins said second die portion to the second lateral wall of the press plate, in such way that the second die portion is attached below a half portion of the central housing of the press plate, and said second fastening structure allowing the second die portion to horizontally move, pushed by a hydraulic cylinder, to contact the first die portion, which in turn is also horizontally moved at the same time, thereby closing the die structure which is formed by both die portions, forming a central aperture whose walls have the shape of the piece to be manufactured, wherein the preform, is located at the same vertical axle with the central housing, and wherein both die portions can vertically move in order to accommodate both portions of the closed die in the central housing.

10. The apparatus for the manufacture of battery terminals as claimed in claim 8, wherein the die structure comprising a first and a second symmetric die portion, each held by a fastening structure, each fixed to a corresponding lateral wall of the press plate in such way that all the structure is able to move upwards and downwards together with the press plate, thus allowing that the corresponding die portion can be moved upwards or downwards and additionally being horizontally moved, pushed or pulled by pushing means in order to open or close the die structure when cooperating with the other die portion, each fastening structure comprising:
a fastening plate having:
a frontal surface, a back surface, a first lateral wall, a second lateral wall, an upper wall and a lower wall;
a rectangular cut, formed at a lower central portion of the fastening plate, having lesser width than the width of the first fastening plate, leaving an horizontal upper bump wall where the cut begins;
a quadrangular surface groove, formed at the back wall, beginning at the upper wall and ending where the rectangular cut begins;
wherein the fastening plate is attached to a lateral wall of the press plate by means of four bolts, in such way that: its back wall contacts a lateral wall of the press plate, forming a closed passing groove with the surface groove of the fastening plate and with the surface of the corresponding lateral wall of the press plate;
a vertical metallic member comprising a quadrangular metallic plate, having a first vertical surface and a second vertical surface, a first vertical longitudinal lateral wall, a second vertical longitudinal lateral wall, a horizontal upper wall and a horizontal lower wall, a perforation located a central portion thereof and two equidistant threaded housings located at the horizontal upper wall, said quadrangular metallic plate being housed in the passing groove formed between the fastening plate in such way that it can slide upwards and downwards with respect to the press plate, wherein a pair of horizontal washers screwed to a respective threaded housing, avoid that said quadrangular metallic plate slide downwards out of the passing groove when the washers bump with the upper wall of the first fastening plate;
a horizontal metallic member, comprising a horizontal metallic block having an upper wall, a lower wall, a first lateral wall, a second lateral wall, a frontal wall and a back wall, said first horizontal metallic member having lesser width than the width of the first vertical metallic member, and having a horizontal longitudinal tunnel located at a central portion thereof beginning at the frontal wall and ending at the back wall, wherein the frontal wall of said horizontal metallic member is attached to the first vertical surface of the vertical metallic member at a lower central portion thereof, in such way that the horizontal tunnel coincides with the perforation located at a central portion of the vertical metallic member, showing a first joining surface and a second joining surface, each having a rectangular surface over the first vertical surface at both sides of the horizontal metallic member and in such way that the horizontal metallic block moves upwards or downwards together with the vertical metallic member along the space left by the quadrangular cut formed at a central lower portion of the fastening plate, and wherein a corresponding end of the upper wall, bumps with the horizontal upper bump wall formed by the quadrangular cut of the first fastening plate when moving upwards, thus avoiding that the vertical metallic member and horizontal metallic member to excessively slide upwards in such way that the vertical metallic member slides out of the passing groove;
a horizontal fastening arm having a first threaded end and a second end having a clamp receiving portion to connect with pushing means, said horizontal fastening arm slidably passing through the perforation of the vertical metallic member and through the horizontal longitudinal tunnel, and connected to the threaded housing of the corresponding symmetric die portion thereby connecting said symmetric die portion to the first fastening structure in such way that said symmetric die portion is able to move upwards and downwards and move horizontally pushed by pushing means connected to the second end of the first horizontal fastening arm.

11. The apparatus for the manufacture of battery terminals as claimed in claim 8, wherein the die structure comprising a first and a second symmetric die portion, each held by a fastening structure, each fixed to a corresponding lateral wall of the press plate in such way that all the structure is able to move upwards and downwards together with the press plate, thus allowing that the corresponding die portion can be moved upwards or downwards and additionally being horizontally moved, pushed or pulled by pushing means in order to open or close the die structure when cooperating with the other die portion, each fastening structure having a horizontal fastening arm having a joining portion for connecting to a corresponding die pneumatic cylinder, said die pneumatic cylinder supported by a structure comprising:
a first longitudinal support member comprising an elongated rectangular beam having first end and a second end, a first lateral surface, a second lateral surface, a frontal surface located at the first end and a back surface located at the second end, wherein the frontal surface is joined to the fastening structure;
a second longitudinal support member comprising an elongated rectangular beam having first end and a second end, a first lateral surface, a second lateral surface, a frontal surface located at the first end and a back surface located at the second end, wherein the frontal surface is joined to the fastening structure;
a transversal support member comprising an elongated rectangular shaped member having a first end, a second end, a frontal wall, a back wall and a circular shaped passage located at a central portion thereof, wherein said transversal support member is transversally joined to the back walls of the first longitudinal support member and of the second longitudinal support member by means of bolts;
wherein the die pneumatic cylinder is joined to the frontal surface of the transversal support member of the first support structure, and having a piston, wherein said piston passes through the passage of the transversal support member and having a clamp at its end, which loosely connects to the horizontal fastening arm in order to avoid excessive tensions during operation.

12. The apparatus for the manufacture of battery terminals as claimed in claim 5, wherein the punching means comprising:
a hydraulic punching cylinder having a piston;
an elongated punching member joined to the piston;
wherein the hydraulic punching cylinder is joined to the upper surface of the upper metallic plate of the support structure.

13. The apparatus for the manufacture of battery terminals as claimed in claim 5, additionally comprising means for providing a metallic preform to the fixed die, said means for providing a metallic preform comprising:
a metallic preform receiving section joined to the front wall of the quadrangular shaped lower metallic plate;
a vertical stacker tube, for vertically stacking a plurality of preforms, said stacker tube ending at the metallic preform receiving section;
a preform feeding arm having a first end and a second end, wherein the first end is joined to a preform pneumatic feeding cylinder and the second end has a preform clamping section that coincides with the end of the vertical stacker tube;
wherein the piston of the of the preform pneumatic feeding cylinder pushes the preform feeding arm until the preform clamping section coincides with the central die housing so that the preform can fall by gravity over said central die housing.

14. The apparatus for the manufacture of battery terminals as claimed in claim 5, additionally comprising means for receiving a partially formed piece, for receiving a partially formed piece when the die structure is opened in order to provide the partially formed piece to the punching means, said means for receiving a partially formed piece comprising:
support means comprising a “L” shaped polygonal metallic member, having:
a main portion and an elongated secondary portion depending from the main portion;
a main straight wall;
a base wall;
an “L” shaped coupling wall; and
a passage located at the secondary portion;
wherein the support means are joined to the quadrangular shaped lower metallic plate in such way that the “L” shaped coupling wall joins to the back wall of the quadrangular shaped lower metallic plate in such way that the base wall is vertically disposed, the main portion is located over the upper surface of the “L” shaped coupling wall and the main straight wall is horizontally disposed;
a joining plate for a pneumatic cylinder for reception means, having a frontal surface and a back surface, wherein the frontal surface is joined to the base wall in such way that a portion of the joining plate protrudes over the main surface of the support means, said protruding portion having a passage;
a pneumatic cylinder for reception means of partially formed pieces, joined to the back surface of the joining plate, wherein the pneumatic cylinder for reception means having a piston that passes through the passage of said joining plate;
reception means of formed pieces, comprising a rectangular shaped reception member, having:
a first longitudinal end and a second longitudinal end;
an upper surface and a lower surface;
a frontal wall and a back wall;
a conic cavity for receiving formed pieces located at the first longitudinal end;
a passage located at a portion near the second longitudinal end;
wherein the back wall is joined to the piston of the pneumatic cylinder for reception means of partially formed pieces for pulling or pushing the rectangular shaped reception member, which is disposed over the main straight wall of the “L” shaped polygonal metallic member of the support member in such way that it slides over said main straight wall pulled or pushed by said pneumatic cylinder for reception means of partially formed pieces;
wherein the pneumatic cylinder for reception means of partially formed pieces pushes the rectangular shaped reception member until the conic cavity coincides with the central aperture of the closed die structure when it is at an elevated position over the fixed die, in such way that it can receive a formed piece when the central perforation of the closed die holds a formed piece and it opens, thus dropping the formed piece in said conic cavity; and
wherein the passage of the reception means coincides with the passage of the lower metallic plate when the pneumatic cylinder for reception means of partially formed pieces pushes the rectangular shaped reception member until the conic cavity coincide with the central perforation of the closed die structure, thereby forming a single passage completely crossing the lower metallic plate and the support means.

15. The apparatus for the manufacture of battery terminals as claimed in claim 1, additionally comprising perforating means, for perforating a partially formed piece, said perforating means joined to the support structure.

16. The apparatus for the manufacture of battery terminals as claimed in claim 5, additionally comprising perforating means, for perforating a partially formed piece, said perforating means comprising:
a hydraulic piercing cylinder having a piston, said piston having a piercing member at its end;
wherein the hydraulic piercing cylinder is joined to the upper surface of the quadrangular shaped upper metallic plate of the support structure, and the piston passes through the aperture located at a portion near the back portion of the quadrangular shaped upper metallic plate; and
wherein the piston together with the piercing member are pulled upwards once the piercing member perforates the formed piece, leaving the formed piece releasably coupled to the piercing member.

17. The apparatus for the manufacture of battery terminals as claimed in claim 16, further including means for decoupling a punched formed piece from the piercing member, comprising:
a fixed upper plate, joined to an upper portion of the piston of the hydraulic piercing cylinder, located below the lower surface of the upper metallic plate of the support structure alongside the push metallic plate of the press means, said fixed upper plate having two equidistant perforations longitudinally located following a collinear axle with the end of the metallic push plate;
a lower movable plate, attached to the upper fixed plate, located immediately below the fixed upper plate and in front of the piercing member, two bolts joined to the upper surface, each passing through one of the equidistant perforations of the upper fixed plate, in such way that an upper portion of each bolt, and the head of each bolt is located over the upper surface of the fixed upper plate and immediately below the lower surface of the upper metal plate of the support structure, and in such way that each bolt can slide trough said equidistant perforations, thus allowing that the lower movable plate can be moved upwards or downwards;
a first spring and a second spring, each having a first and a second end, and each coiled around the upper portion of a corresponding bolt, each one located between the upper surface of the fixed upper plate and the head of the corresponding bolt; and
wherein the first end of each spring contacts the head of a corresponding bolt, and the second end of each spring contacts the upper surface; and
wherein said first and second spring avoid that the movable lower plate slide downwards, because when the weight thereof pulls each bolt downwards, the head of each bolt tries to compress a corresponding bolt against the upper surface of the upper fixed plate, and each spring exerts an elastic force upwards over the head of the corresponding bolt, thus maintaining the upper portion of each bolt over the surface of the upper fixed plate;
wherein the means for decoupling a punched formed piece from the piercing member, move upwards and downwards together with the piston of the hydraulic piercing cylinder, in such way that when the punching means finish perforating a preformed piece and said piece ends releasably coupled to the piercing member, the hydraulic punching cylinder moves the piston, the means for decoupling a punched formed piece upwards until the heads of each bolt contact the lower surface of the upper metallic plate and maintain the lower movable plate at a fixed vertical position while the upper fixed plate slides guided by the bolts and moves upwards together with the piston and with the piercing member, until the periphery of the pierced piece that is moving upwards together with the piercing member, bumps with the lower surface of the movable lower plate while the piercing member move upwards, thus allowing the pierced piece to decouple from the piercing member and fall by gravity.

18. The apparatus for the manufacture of battery terminals as claimed in claim 1 additionally comprising;
means for providing a preform to the fixed die;
means for receiving a partially formed piece, for receiving a partially formed piece when the die structure is opened in order to provide the partially formed piece to the punching means;
and wherein
the press plate is moved by press means driven by a hydraulic press cylinder having a piston;
each portion of the die structure is driven by means of a pneumatic cylinder having a piston;
the perforating means are driven by a hydraulic piercing cylinder having a piston;
the punching means are driven by a hydraulic punching cylinder having a piston;
the means for providing a metallic preform to the fixed die are driven by a preform pneumatic feeding cylinder having a piston;
the means for receiving a partially formed piece are driven by a pneumatic cylinder having a piston.

19. The apparatus for the manufacture of battery terminals as claimed in claim 1, additionally comprising;
means for providing a preform to the fixed die;
means for receiving a partially formed piece, for receiving a partially formed piece when the die structure is opened in order to provide the partially formed piece to the punching means;
and wherein
the press plate is moved by press means driven by a hydraulic press cylinder having a piston;
each portion of the die structure is driven by means of a pneumatic cylinder having a piston;
the perforating means are driven by a hydraulic piercing cylinder having a piston;
the punching means are driven by a hydraulic punching cylinder having a piston;
the means for providing a metallic preform to the fixed die are driven by a preform pneumatic feeding cylinder having a piston;
the means for receiving a partially formed piece are driven by a pneumatic cylinder having a piston;
wherein each pneumatic cylinder and each hydraulic cylinder are controlled by electronic control means.

20. The apparatus for the manufacture of battery terminals as claimed in claim 1, additionally comprising;
means for providing a preform to the fixed die;
means for receiving a partially formed piece, for receiving a partially formed piece when the die structure is opened in order to provide the partially formed piece to the punching means;
and wherein
the press plate is moved by press means driven by a hydraulic press cylinder having a piston;
each portion of the die structure is driven by means of a pneumatic cylinder having a piston;
the perforating means are driven by a hydraulic piercing cylinder having a piston;
the punching means are driven by a hydraulic punching cylinder having a piston;
the means for providing a metallic preform to the fixed die are driven by a preform pneumatic feeding cylinder having a piston;
the means for receiving a partially formed piece are driven by a pneumatic cylinder having a piston;
wherein the piston of each pneumatic cylinder is magnetic and each pneumatic cylinder and each hydraulic cylinder are controlled by electronic control means;
and further comprising:
means for detecting the position of each pneumatic cylinder comprising:
a beginning of displacement sensor and an end of displacement sensor for a first die pneumatic cylinder, each located at the body of the pneumatic cylinder;
a beginning of displacement sensor and an end of displacement sensor for a second die pneumatic cylinder, each located at the body of the pneumatic cylinder;
a beginning of displacement sensor and an end of displacement sensor for the preform pneumatic feeding cylinder, each located at the body of the pneumatic cylinder;
a beginning of displacement sensor and an end of displacement sensor for the pneumatic cylinder for reception means of partially formed pieces, each located at the body of the pneumatic cylinder;
means for detecting the position of the piston of the hydraulic piercing cylinder comprising: a start of displacement inductive proximity sensor, a middle displacement inductive proximity sensor, an end of displacement inductive proximity sensor, each one connected to the electronic control means and each located at a vertical bar attached between upper metallic plate and the lower metallic plate, each sensor sensing a detectable element joined to said of the hydraulic piercing cylinder;
means for detecting the position of piston of the hydraulic press cylinder, comprising:
a start of displacement inductive proximity sensor, a middle displacement inductive proximity sensor, an end of displacement inductive proximity sensor, each one connected to the electronic control means and each located at the body of the hydraulic cylinder;
a first detectable element attached to the first lineal guide bar, located at a place that corresponds to the beginning of displacement of the piston of the hydraulic press cylinder, and a second detectable element attached to the first lineal guide bar, located at a place that corresponds to the end of displacement of the piston of the hydraulic press cylinder;
means for detecting the position of the piston of the hydraulic punching cylinder, comprising a beginning of displacement pressure sensor, and an end of displacement pressure sensor, each one connected to the electronic control means and each attached to the oil inlet/outlet port of the piston of the hydraulic punching cylinder respectively, said sensors able to be regulated and detecting when the internal pressure of the internal cavities of the hydraulic punching cylinder raise until a predetermined value, in such way that when the piston of the hydraulic punching cylinder ends punching a piece, the internal pressure rises to 3000 psi, which is detected by the end of displacement pressure sensor and is interpreted by the electronic control means as the end of displacement for the piston of the hydraulic punching cylinder, and when the piston of the hydraulic punching cylinder retracts to its initial position of beginning of displacement, the internal pressure decreases and is interpreted by the electronic control means as beginning of displacement for the piston;
wherein each sensor is connected to the electronic control means.

21. The apparatus for the manufacture of battery terminals as claimed in claim 13, additionally comprising:
means for detecting a preform for providing it to the vertical stacker tube, said means for detecting a preform, connected to the electronic control means, comprising:
means for emitting a light beam, located at the lower end of the vertical stacker tube;
an optical sensor, located at the lower end of the vertical stacker tube, opposed to the means for emitting a light beam;
wherein any preform ready to be provided, stands between means for emitting a light beam and the optic sensor, thus causing that the optic sensor stops receiving the light beam, which is interpreted by the electronic control means that a preform is ready to be provided.

22. A method for manufacturing battery terminals comprising:
a) providing a metallic preform;
b) introducing the metallic preform into a fixed metallic die;
c) providing a die structure formed by at least two portions that can be opened and closed in such way that when closed, they form a central aperture whose walls form the shape of the piece to be produced;
d) pressing the die structure against the fixed metallic die in such way that the metallic preform enters the central aperture;
e) pressing the metallic preform against the walls of the central aperture and against the fixed metallic die for producing a hollow metallic piece having a lower wall;
f) open the die structure in order to liberate the hollow metallic piece from the die structure;
g) perforate the lower wall of the hollow metallic piece.
